(19) United States
(12) Patent Application Publication
(10) Pub. No.: US 2010/0073501 A1
(43) Pub. Date: Mar. 25, 2010

(54) DIGITAL IMAGE CAPTURE DEVICE AND HEAD PORTRAIT GENERATING METHOD THEREOF

(75) Inventor: Chang-Wei CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/406,056

(22) Filed: Mar. 17, 2009

(30) Foreign Application Priority Data
Sep. 19, 2008 (CN) 200810304579.5

(51) Int. Cl. H04N 5/228; G06K 9/00

(52) U.S. Cl. 348/222.1; 382/118; 348/E05.031

(57) ABSTRACT

A digital image capture device includes a camera module, a face recognition module, a portrait capture module, a regulation module and a storage module. The camera module captures an image. The face recognition module recognizes any human face from the captured image. The portrait capture module copies the recognized face portion as a head portrait with a predetermined length-to-width ratio. The regulation module stores a plurality of groups of settings and regulates the copied head portrait according to a group of settings selected from the groups of settings. Each group of settings is compliant with requirements of a forum or an instant messaging program. The storage module stores the regulated head portrait.

### BACKGROUND

1. Technical Field

The present disclosure relates to image capture devices and, particularly, to a digital image capture device capable of directly outputting head portraits and a head portrait generating method thereof.

2. Description of the Related Art

In many online forums and instant messaging (IM) programs, such as Microsoft Network (MSN®) messenger, users can set their favorite images as their personalized head portraits. However, parameters of the favorite images captured by current digital image capture devices, such as the size and/or the compression ratio thereof, must satisfy the requirements of the head portraits set by the forums and IM programs. Otherwise, the setting may be refused, or even the setting is accepted, the set head portrait may be distorted. In order to solve this problem, the users need to modify the image with image editing software. This is inconvenient.

Therefore, what is needed is a digital image capture device and a head portrait generating method thereof, which can overcome the above-mentioned problem.

### BRIEF DESCRIPTION OF THE DRAWINGS

FIG. 1 is a functional block diagram of a digital image capture device, according to an exemplary embodiment.

FIG. 2 is a flowchart of a head portrait generating method using the digital image capture device of FIG. 1, according to an exemplary embodiment.

### DETAILED DESCRIPTION

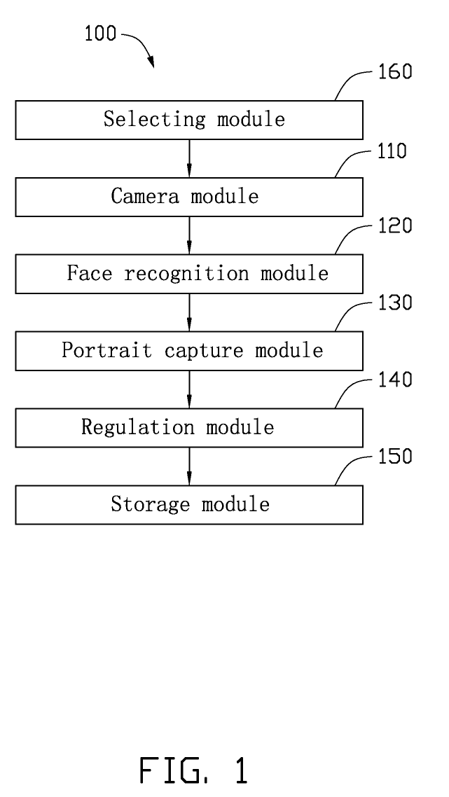

Referring to FIG. 1, a digital image capture device 100 such as a digital still camera, according to an exemplary embodiment, includes a camera module 110, a face recognition module 120, a portrait capture module 130, a regulation module 140, a storage module 150, and a selecting module 160.

The camera module 110 includes a lens, an image sensor, controlling units, and image processing units (not shown). The lens is configured for forming an optical image on the image sensor. The image sensor, such as a charge-coupled device (CCD), is configured for converting the optical image into corresponding electrical signals. The controlling units may include an auto-focus controlling unit, an auto-exposure controlling unit and an auto-white-balance controlling unit, and are configured for controlling corresponding aspects of the camera module 110. The image processing units may include a color space converting unit, a gamma correcting unit, and a joint photographic experts group (JPEG) encoding unit, and are configured for processing the electrical signals for various intends to finally output a corresponding image.

The face recognition module 120 is configured for recognizing any human face in a image captured by the camera module 110. If the image includes a face, the face recognition module 120 recognizes facial features of the face and generates a frame to frame the face portion in the image according to the facial features. For the face recognition module 120, many face recognition algorithms, including nerve network, nerve network plus fast Fourier transform, fuzzy plus nerve network, RGB normalized color, fuzzy color, principle component analysis, and algorithm template, can be used to detect face(s) in the image.

The portrait capture module 130 is configured for copying the recognized face portion as a head portrait with a predetermined length-to-width ratio.

The regulation module 140 is configured for storing a plurality of groups of settings. Each group of settings is compliant with the requirements of a corresponding popular forum or an IM program. The regulation module 140 is also configured for regulating the head portrait, according to a selected group of settings. For example, the regulation module 140 regulates the resolution, the length and the width of the head portrait. In this embodiment, the IM program is MSN® messenger. The required resolution of the head portrait compliant with the MSN® messenger is 96×96.

The storage module 150 is configured for storing the copied head portraits so that users can upload the stored head portraits directly output from the digital image capture device 100 to an online forum or the IM programs as their personalized head portraits. The selecting module 160 is configured for selecting a group of settings from the plurality of groups of settings in response to users input. The selecting module 160 may be an input interface. The users choose the selected group of settings through the selecting module 160.

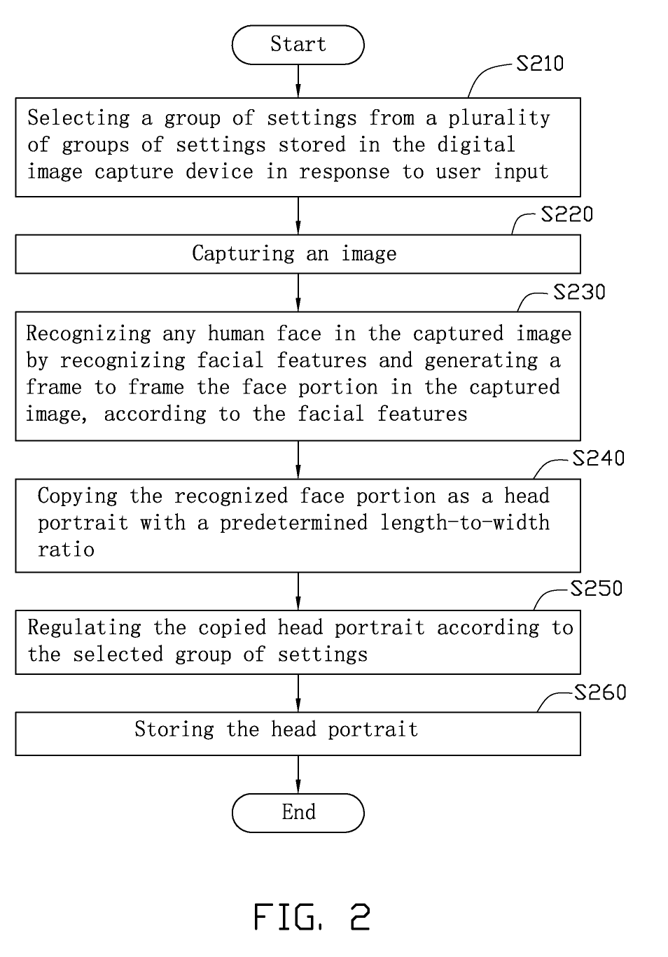

Referring to FIG. 2, a method for generating a head portrait, according to an embodiment, can be exemplarily implemented by the digital image capture device 100 and includes the following steps 210-260.

Step 210: selecting a group of settings from a plurality of groups of settings stored in the digital image capture device 100 in response to user input. In particular, the groups of settings are stored in the regulation module 140. Each group of settings is compliant with requirements of a corresponding popular forum or an IM program. The group of settings includes resolution, length and width of the head portrait. In this embodiment, the IM program is a MSN messenger. The required resolution of the head portrait compliant with the MSN® messenger is 96×96. This step can be carried out by the selecting module 160.

Step 220: capturing an image. This step can be carried out by the camera module 110.

Step 230: recognizing any human face in the captured image by recognizing facial features and generating a frame to frame the face portion in the captured image, according to the facial features. This step can be carried out by the face recognition module 120.

Step 240: copying the recognized face portion as a head portrait with a predetermined length-to-width ratio. This step can be carried out by the portrait capture module 130.

Step 250: regulating the copied head portrait according to the selected group of settings. This step can be carried out by the regulation module 140.

Step 260: storing the head portrait. As a result, the users can upload the stored head portrait directly output from the digital image capture device to the forum or the IM programs as their personalized head portraits without assistant of other external devices.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A digital image capture device comprising:
a camera module configured for capturing an image;
a face recognition module configured for recognizing any human face from the captured image;
a portrait capture module configured for copying the recognized face portion as a head portrait with a predetermined length-to-width ratio;
a regulation module configured for storing a plurality of groups of settings and regulating the copied head portrait according to a group of settings selected from the groups of settings, wherein each group of settings is compliant with requirements of a forum or an instant messaging program; and
a storage module configured for storing the regulated head portrait.

2. The digital image capture device as claimed in claim 1, wherein the digital image capture device further comprises a selecting module, being configured for selecting a group of settings from the groups of settings in response to user input.

3. The digital image capture device as claimed in claim 1, wherein the face recognition module is configured to recognize facial features of the face and generate a frame to frame the face portion in the image according to the facial features.

4. The digital image capture device as claimed in claim 1, wherein the selected group of settings comprises resolution, length and width of the head portrait.

5. The digital image capture device as claimed in claim 4, wherein the resolution of the regulated head portrait is 96×96.

6. The digital image capture device as claimed in claim 1, wherein the face recognition module uses a face recognition algorithm selected from the group consisting of nerve network, nerve network plus fast Fourier transform, fuzzy plus nerve network, RGB normalized color, fuzzy color, principle component analysis, and algorithm template.

7. A method for generating a head portrait, comprising:
selecting a group of settings from a plurality of groups of settings stored in a digital image capture device in response to user input;
capturing an image using the digital image capture device;
recognizing any human face in the image using a face recognition module in the digital image capture device;
copying the recognized face portion as a head portrait with a predetermined length-to-width ratio;
regulating the head portrait according to the selected group of settings;
storing the head portrait.
